(19) United States
(12) Patent Application Publication
(10) Pub. No.: US 2005/0285384 A1
(43) Pub. Date: Dec. 29, 2005

(54) Magnetically closed foldable map

(76) Inventor: Nancy Laura Judson, Westport, CT (US)

Correspondence Address: Nancy Laura Judson, 15 Oak St., Westport, CT, 06880, US

(21) Appl. No.: 10/877,182

(22) Filed: Jun. 28, 2004

(51) Int. Cl. G09B 29/00

(52) U.S. Cl. 283/34

(57) ABSTRACT

A map sheet that folds down, via side to side accordion folds and top to bottom inward fold, to the approximate size of a credit card or larger, and is secured to a protective outer cover which closes with a magnetic closure so that the map does not pop open when folded down to its smaller size.

### CROSS REFERENCE OF PATENTS

U.S. Pat. No. 4,606,553—Nickerson

### STATEMENT REGARDING FEDERALLY SPONSORED RESEARCH OR DEVELOPMENT

N/A

### REFERENCE TO SEQUENCE LISTING, A TABLE, OR A COMPUTER PROGRAM LISTING COMPACT DISC APPENDIX

N/A

### BACKGROUND OF THE INVENTION

This invention pertains generally to map construction, and more particularly to a map that folds for compact storage and will not pop open when folded down and transported. More specifically, this invention contemplates a map which is configured with a plurality of folds to permit it to be folded down for compact storage and which: a) is easy to transport because of its compact size, b) is protected from the elements because of an attached rigid cover which encases the map once folded, and c) remains sealed when not in use by means of magnetic closure attached to the cover, said magnetic closure preventing the map from popping open.

Most detailed maps require a relatively large print area and are fanfolded vertically and then folded top to bottom for portability. This large number of folds prevents the map from laying flat, and makes it pop open involuntarily when it is transported. Accordingly, the map is bulky, hard to carry and subject to wear and tear.

Prior Art maps have been encased in matchbook-like cover with a tuck tab (U.S. Pat. No. 4,606,553) but the user has to first close the cover, and then physically tuck the tab in after use. Once inside a pocket or purse, the tab can easily get caught on other items because the lower portion juts out, and the map closure can be easily ruined as can the map itself.

The present invention is intended to seal the map closed when not in use by a magnetic closure which requires no active movement on the part of the user other than just shutting the cover closed and allowing the magnets to connect; moreover, the strength of magnets will keep the cover closed within a purse or pocket and the map will not pop open.

### SUMMARY OF THE INVENTION

It is the object of the present invention to provide an improved map construction so that a map printed on a sheet larger than its attached cover will easily fold down to a compact size, and thus make it easy to transport in a wallet or purse.

It is the further object of the invention to protect the map from the elements; a protective outer cover is permanently attached to the map itself and encases the map when it is folded down.

It is the further object of the invention to make the map stay closed and not pop open when the map is not in use.

These objects are achieved in the present invention which involves a map comprised of a plurality of side to side accordion folds, and at least one top to bottom inward fold; such that the number and size of side to side and top to bottom folds of the page are sufficient to reduce the size of the map so it fits, when folded down, within the perimeter of a protective outer cover that is approximately the size of a credit card or larger. The protective outer cover is secured to the map page and is made of heavier material than the map sheet, and said outer cover has a magnetic closure to keep the cover closed and prevent the map from popping open when not in use.

### BRIEF DESCRIPTION OF THE SEVERAL VIEWS OF THE DRAWINGS

FIGS. 1-3 are step by step perspective views of the way the cover is opened and the map is unfolded

FIGS. 4 and 5 are step by step views of the map refolded and closed within the cover

FIG. 6 is a view of the cover closing with the magnetic closure

FIG. 7 is a view of the cover closed

FIG. 8 is a view of the construction of the magnetic closure

### DETAILED DESCRIPTION OF THE INVENTION

Often, large size maps involuntarily pop open because of the number of folds required to make them portable. It is the object of the present invention to provide an improved map construction which enables an individual to more easily transport a relatively large sized map in a compact format, and keep the map closed when it is transported by means of a magnetic closure on the cover.

With this invention, a large format map folds down to a compact size, is encased within an attached protective outer cover and said cover is sealed with a magnetic closure.

The map constructed to accomplish this is as follows:

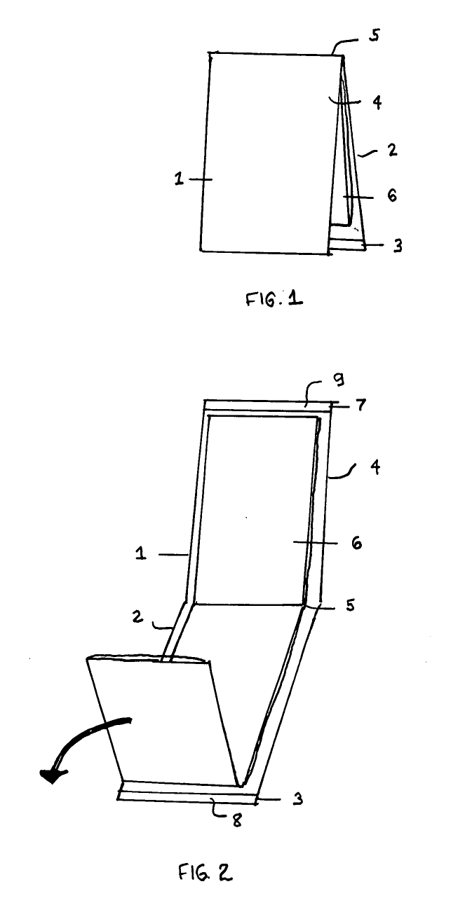

Referring to FIG. 1, the map construction comprises an outer cover 1 made of semi-rigid material that is heavier than the map sheet 6. Specifically this outer cover 1 is folded in half 5 to create a front cover 4 and a back cover 2, and when folded, this outer cover 1 is approximately the size of a credit card or larger.

Referring to FIG. 8, a small inside front flap 7 is created on front cover 4 by tucking under approximately ¼″ of front cover 4, and a small inside back flap 3 is created on back cover 2 by tucking under approximately ¼″ of the back cover 2. Tucked under the flap on the inside front cover 4 is a magnet 9, and tucked under the flap on the inside back cover 2 is a magnet 8. These magnets are held in place when the edge of the inside front flap 7 is secured to the front cover 4 with adhesive or adhesive-like substance, and the edge of the inside back flap 3 is secured to the back cover 2 with adhesive or adhesive-like substance.

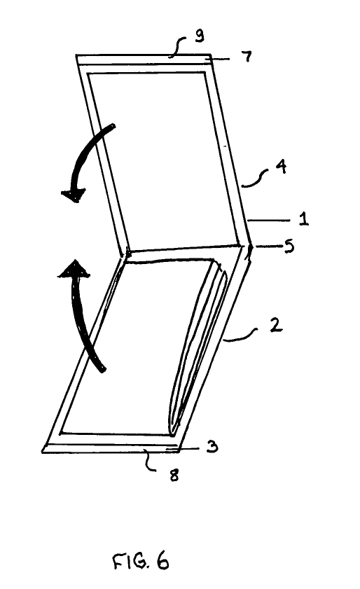

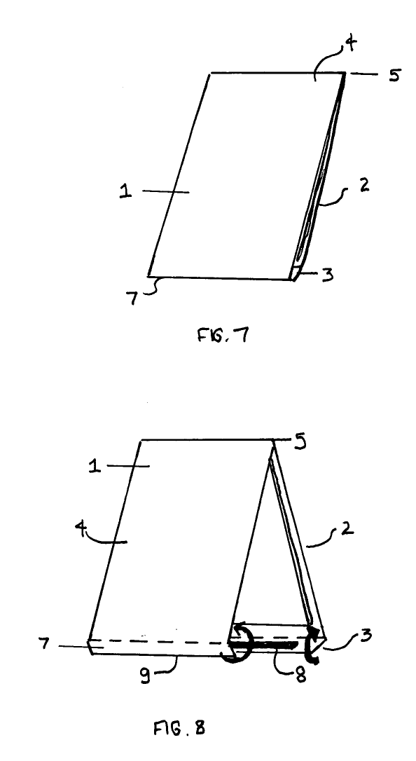

Referring to FIG. 6, when the cover 1 is closed, the magnets 8 and 9 connect and the cover stays closed and the map inside will not pop open.

Referring to FIG. 6, the magnets within the inside front flap 7 and inside back flap 3 are not visible to the user.

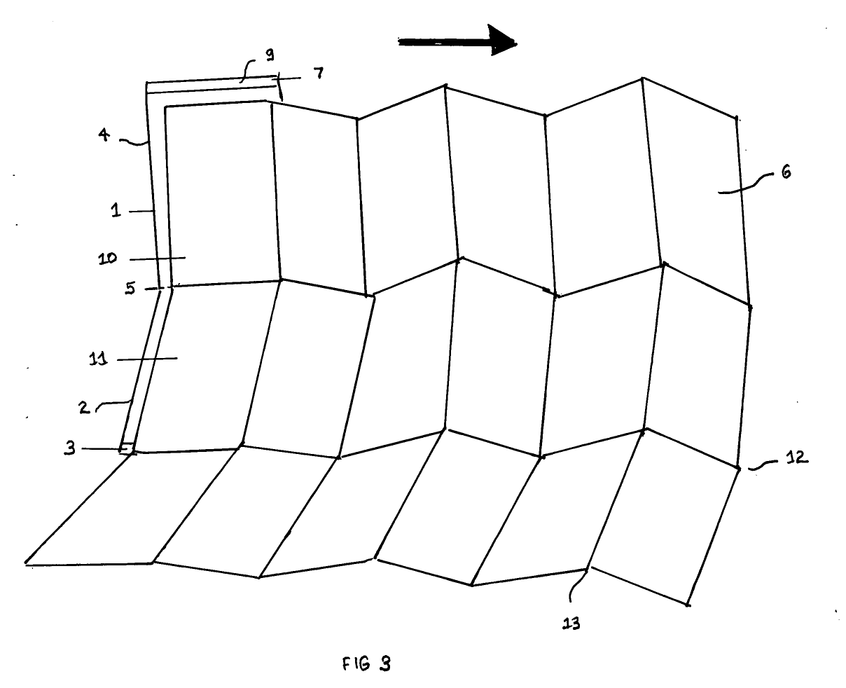

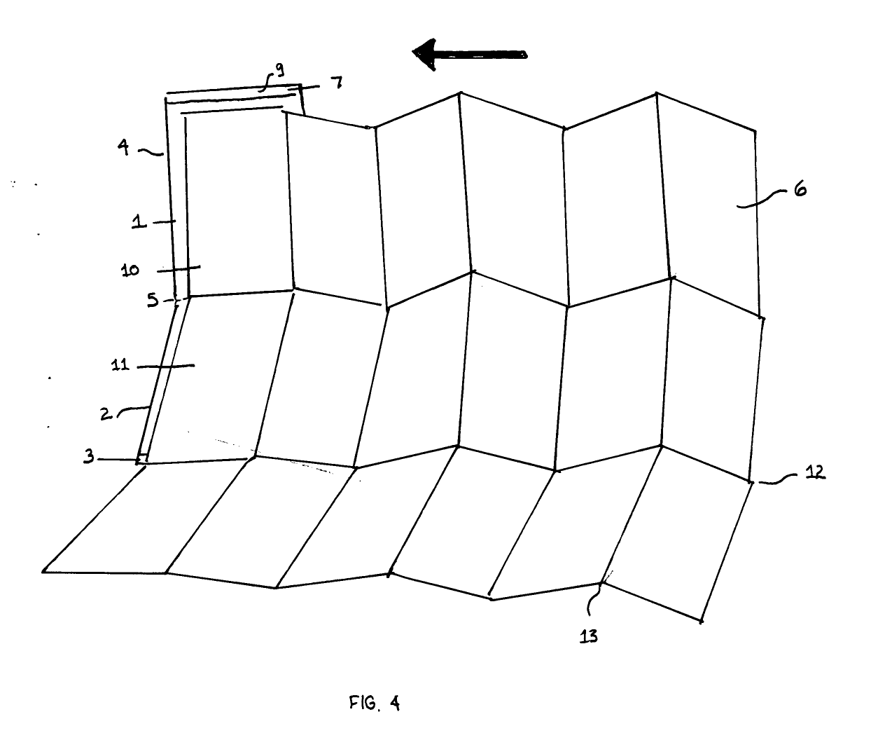

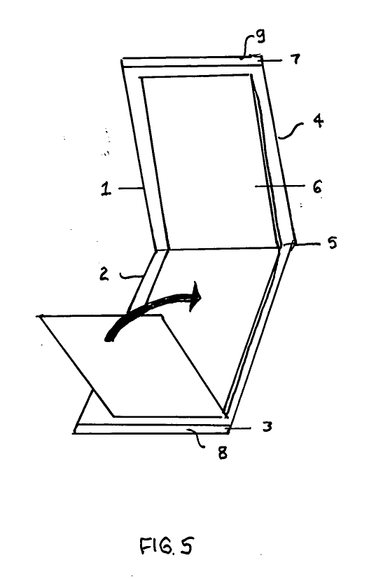

Referring to FIGS. 2 and 3, a sheet of paper or paper-like material is printed with a map 6 and made up of at least one top to bottom inward fold 12 and at least two side to side accordion folds 13.

Referring to FIG. 3, said map 6 is attached to cover 1 by securing the upper left panel 10 to the inside of front cover 4 and mid left panel 11 to inside of back cover 2 with adhesive or some other suitable substance.

Referring to FIG. 4, the number and size of folds are sufficient so that when the map 6 folds down, it fits within cover 1.

1. A map structure comprising
a) an outer cover, constructed of heavyweight paper or semi-rigid material, folded in half, and;
b) a page that is larger than the outer cover and constructed of paper or paper like material, or a suitable flexible material, and said page is printed with a map and constructed of a plurality of folds such that the number and size of side to side and top to bottom folds of the page are sufficient to reduce the size of the map so it fits, when folded down, within the perimeter of an outer cover;
c) said outer cover is attached to the map page by securing the upper left and/or the middle left panels of the map page to the outer cover with an adhesive so that the map is permanently encased within this outer cover when folded down.
d) said outer cover has two thin flaps along two opposing edges, such flaps created by folding back a thin piece of the cover on each edge and securing each piece back to the cover with an adhesive or adhesive-like substance
e) tucked within each outer cover flap is a magnet, such that the magnets connect when the cover is closed
f) because such magnets are tucked beneath the flaps, they are not readily apparent.
